(19) United States
(12) Patent Application Publication
(10) Pub. No.: US 2007/0244694 A1
(43) Pub. Date: Oct. 18, 2007

(54) Dictionary-content processing apparatus, content displaying system, and content displaying method

(75) Inventor: Akira Hosokawa, Kanagawa (JP)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 11/524,658

(22) Filed: Sep. 21, 2006

(30) Foreign Application Priority Data
Mar. 28, 2006 (JP) 2006-89279

(51) Int. Cl. G06F 17/21

(52) U.S. Cl. 704/10

(57) ABSTRACT

In a hierarchical database in which a schema of a property is defined, a group-information creating unit creates group information that properties are automatically grouped based on their metadata. When a property is selected on a content display screen for change of its display position, a content aggregating unit aggregates values of the property and of the linked properties of it based on group information of the property. This allows an operator to operate easily to aggregate a subject property and another property related to the subject property, thereby reducing a workload of the operator.

### CROSS-REFERENCE TO RELATED APPLICATIONS

This application is based upon and claims the benefit of priority from the prior Japanese Patent Application No. 2006-089279, filed on Mar. 28, 2006; the entire contents of which are incorporated herein by reference.

### BACKGROUND OF THE INVENTION

1. Field of the Invention

The present invention relates to a technology for processing and displaying data content of a dictionary.

2. Description of the Related Art

A hierarchical database that is represented by an object-oriented database (OODB) or an object relational database (ORDB) includes a hierarchy in which a lower class inherits a property of its upper class. Each class is associated with data (group) described based on a property belonging to a subject class. The data content (group) is sometimes called as instance(s).

ISO13584/Parts Library (PLIB), which is an international standard for electronic catalogs of industrial products and parts promoted by International Organization for Standardization, is an example of the hierarchical databases. A schema of classes and properties, such as BSU code that indicates a unique identification, and preferred name, is defined in the PLIB. Moreover, metadata of each class or each property is described based on the schema. A classification hierarchy configured in this way is called as the dictionary. Moreover, data content are described based on such a dictionary.

When a schema of a class and a property is defined in a hierarchical database, as in the PLIB, an operator can systematically view and operate the content of the class, through access to the content in conjunction with information of the class and the property.

When an operator views data content in a hierarchical database, to make the operator grasp the content at a glance, the content are often displayed on a graphical user interface (GUI) in a table format that has a header with a property item belonging to a class specified by the operator.

In many application software products that provide presentation in a table format, generally an operator can move a specific property item from a displayed position to another position on a table displayed on a GUI by using a pointing device to drag and drop a header. This allows the operator to move a subject property item to the top of the items, and to arrange other relevant property items adjacent to the subject property item. This arrangement improves operation efficiency.

However, to move a property item, the operator must either know or find out the displayed position of the property item. Consequently, as the number of displayed property items increases, the operation becomes complicated. The operator also needs to grasp what other property is to be simultaneously displayed to view and edit a property item. Consequently, as the number of property items to be displayed increases, the workload on the operator increases, because he must determine and find out the relevant properties.

In most of the spreadsheet software, it is possible to simultaneously select and cutout a plurality of adjacent items, and paste the cutout items at a certain position to move the items together. This enables aggregated moving operation for adjacent items. In some spreadsheet software, it is possible to group adjacent items and place a mark thereby improving visibility of relation between the items.

JP-A 2000-075977 (KOKAI) discloses an information processing device according to which data is recognized as a card; a group of cards is managed in a structure that order of the cards are kept; and when a top card in the group moves along pointed positions, subsequent cards follow the top card. This enables an easy data management.

However, with the common spreadsheet software, although adjacent items can be selected at once and moved together, items that are spaced apart (hereinafter, “separated items”) are required to be moved individually. Furthermore, separated items cannot be aggregated into a group, which is inconvenient.

Moreover, with the technology disclose in JP-A 2000-075977, separated items cannot be managed together.

### SUMMARY OF THE INVENTION

According to an aspect of the present invention, a dictionary-content processing apparatus includes a dictionary-data storing unit that stores dictionary data defined based on a hierarchical data model in which an upper class inherits a property to a lower class; a content storing unit that stores the content described based on the dictionary data; a metadata acquiring unit that acquires metadata of each property from the dictionary data; a grouping unit that creates group information by grouping properties based on the metadata; a group-information storing unit that stores the group information; a displayed content data creating unit that searches the dictionary data present in the dictionary-data storing unit and the content present in the content storing unit to create displayed content data; and a content aggregating unit that aggregates, when a property is selected on a content display screen based on the displayed content data, values of selected property based on group information relating to the selected property present in the group-information storing unit.

According to another aspect of the present invention, a system for displaying content includes a dictionary-data storing unit that stores dictionary data defined based on a hierarchical data model in which an upper class inherits a property to a lower class; a content storing unit that stores content described based on the dictionary data; a metadata acquiring unit that acquires metadata of each property from the dictionary data; a grouping unit that creates group information by grouping properties based on the metadata; a group-information storing unit that stores the group information; a displayed content data creating unit that searches the dictionary data present in the dictionary-data storing unit and the content present in the content storing unit to create displayed content data; a display unit that displays a content display screen based on the displayed content data; an input unit which allows an operator to select a property displayed on the content display screen; and a content aggregating unit that aggregates, when a property is selected on the content display screen, values of selected property based on group information of the selected property present in the group-information storing unit.

According to still another aspect of the present invention, a method of displaying content includes storing dictionary data into a dictionary-data storing unit defined according to a hierarchical data model in which an upper class inherits a property to a lower class; storing content described based on the dictionary data into a content storing unit; acquiring metadata of each property from the dictionary data present in the dictionary-data storing unit; creating group information by grouping properties based on the metadata; storing the group information into a group-information storing unit; searching the dictionary data present in the dictionary-data storing unit and the content present in the content storing unit and creating displayed content data; displaying on a display unit a content display screen based on the displayed content data; selecting with an input unit a property displayed on the content display screen; aggregating, when a property is selected with the input unit on the content display screen, values of selected property based on group information of the selected property present in the group-information storing unit.

### BRIEF DESCRIPTION OF THE DRAWINGS

FIG. 1 is a schematic for explaining an example of a hierarchical dictionary according to an embodiment of the present invention;

FIG. 2 is a schematic for explaining an example of a simple tree structure of a hierarchical dictionary according to the PLIB standard;

FIG. 3 is a schematic of a content displaying system according to the embodiment;

FIG. 4 is an example of module structure of a server and client terminals;

FIG. 5 is a detailed functional diagram of the content displaying system;

FIG. 6 is a schematic for systematically explaining a structure of a hierarchical database;

FIG. 7 is an example of a schema of properties;

FIG. 8 is an example of dictionary data present in a dictionary-data storing unit shown in FIG. 5;

FIG. 9 is an example of content data, when the content data is stored in a relational database;

FIG. 10 is an example of content data, when the content data are stored by providing a content table per class;

FIG. 11 is an example of a screen for displaying content (hereinafter, “content displaying screen”);

FIG. 12 is a schematic for explaining dragging operation by an operator for dragging a property item;

FIG. 13 is a flowchart of a process for creating group information;

FIG. 14 is an example of a table registered in a group-information storing unit shown in FIG. 5;

FIG. 15 is an example of a screen for setting a group (hereinafter, group setting screen”);

FIG. 16 is another example of the group setting screen;

FIG. 17 is an example of a screen for setting a priority-level (hereinafter, “priority-level setting screen”);

FIG. 18 is another example of the priority-level setting screen;

FIG. 19 is still another example of the group setting screen;

FIG. 20 is a flowchart of a process for moving together with a linked property item;

FIG. 21 is a flowchart of a process for creation of list of property to be moved shown in FIG. 20;

FIG. 22 is a flowchart of a process for creation of display data (renew) shown in FIG. 20;

FIG. 23 is a schematic for explaining movement of an item in a table; and

FIG. 24 is another schematic for explaining movement of an item in a table.

### DETAILED DESCRIPTION OF THE INVENTION

Exemplary embodiments of the present invention will be explained below in detail with reference to accompanying drawings.

First, a structure of a hierarchical dictionary that is used in an embodiment of the present invention will be explained. Such a hierarchical dictionary stores therein metadata to be used in an electronic catalog system that provides product information electronically. The metadata defines descriptive specifications of data (for example, content). The metadata is configured in a database to be delivered as independent data of information corresponding to a database schema (table name, property name, relation, and the like), and distinguished from general data. Such metadata is called as the dictionary or the dictionary data according to the standard of ISO13584 or a standard of IEC61360, which is another international standard designed by International Electrotechnical Commission.

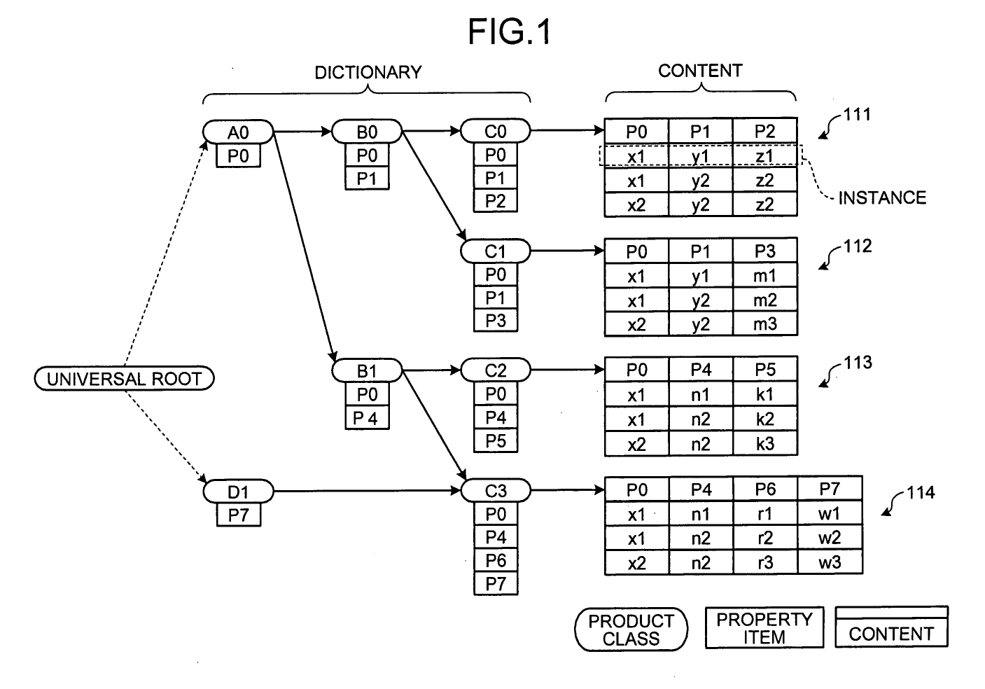

FIG. 1 is a schematic for explaining a structure of a hierarchical dictionary. The hierarchical dictionary is a hierarchical database and it is divided into a plurality of layers. Each layer includes one or more categories, and a lower layer inherits a property of its upper layer. Accordingly, a category in a lower layer inherits a property of a category in its upper layer. A category in a hierarchical classification is called as a class, and each class has a property. The hierarchical dictionary shown in FIG. 1 depicts general inheritance relation between classes including multiple inheritances. Each of A0, B0, B1, C0, C1, C2, C3, and D1 denotes a class, and each of P0 to P7 denotes a property. For example, the class C3 inherits properties P0 and P4 from its parent class B1, inherits a property P7 from another parent class D1, and a property P6 is additionally defined in the class C1. The classes A0 and D1 are independent root classes. A universal root is a global class that virtually includes the whole root classes. This is equivalent to a so-called universal set generally used in mathematics. Precisely, the global class includes no property to inherit and no its own property, so that the global class can be treated as a parent class of the whole root classes.

The PLIB standard (ISO13584 parts Library) is an international standard for implementing an electronic catalog system to provide product information electronically. In the PLIB standard, the hierarchical structure to be used for a product classification and its properties is a simple tree structure. In other words, in the PLIB standard, a class belongs to only one upper class (parent class) for its own. When the class inherits a property from other than the parent class, case of, which is a special structure for importing (referring) a property, is used. This arrangement presents a case where the multiple inheritances in FIG. 1 is appropriately divided into a main sequence and a sub-sequence, for example, by allocating a parent class with the smallest number to the main sequence, and the sub-sequence is given an alias, case of. On the contrary, in an object relational database (ORDB) or an ordinary object-oriented database, not all the classes belong to a parent table or a parent class. However, any class, even an independent table or class, can be traced from one root by setting the virtual universal root as shown in FIG. 1, so that the structure does not differ from a simple tree.

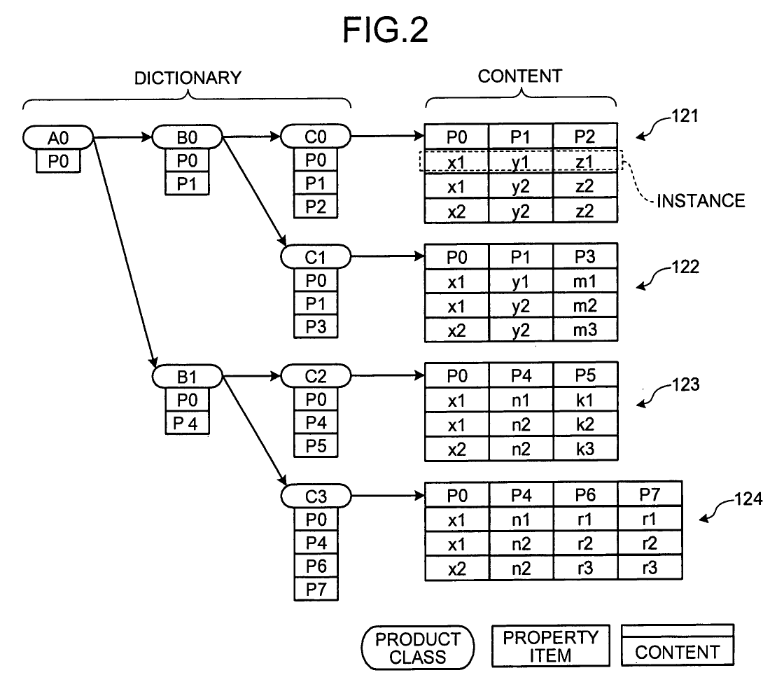

FIG. 2 is a schematic for explaining an example of the structure of a hierarchical dictionary according to the PLIB standard that has a simple tree structure. The hierarchical dictionary according to the PLIB standard omits the universal root. In FIG. 2, each of A0, B0, B1, C0, C1, and C2 presents information including a classification hierarchy. The tree according to the embodiment is a simple tree, in the sense that each class belongs to only one upper class for its own.

As shown in FIG. 2, the class A0 has lower classes B0 and B1. The class B0 has lower classes C0 and C1, and the class B1 has lower classes C2 and C3. Each class has one or more property items, and properties of an upper class are inherited to its lower classes. Content 121, 122, 123, and 124 in FIG. 2 are groups of product data. For example, the content 121 is a product data group categorized into a type C0, and a row of the content constitutes a product categorized in C0, while a column indicates a property item and a property value (instance) of each product. For example, the content 121 include three products: a product of which values of property items P0, P1, and P2, are x1, y1, and z1 respectively; another product of which respective values are x1, y2, and z2; and still another product of which respective values are x2, y2, and z2. Furthermore, each product in the content 121 can also be referred from the upper classes A0 and B0 of the class C0, but only about the property items that each class has.

The content 121 to 124 in FIG. 2 have characteristics similar to content 111 to 114 in FIG. 1.

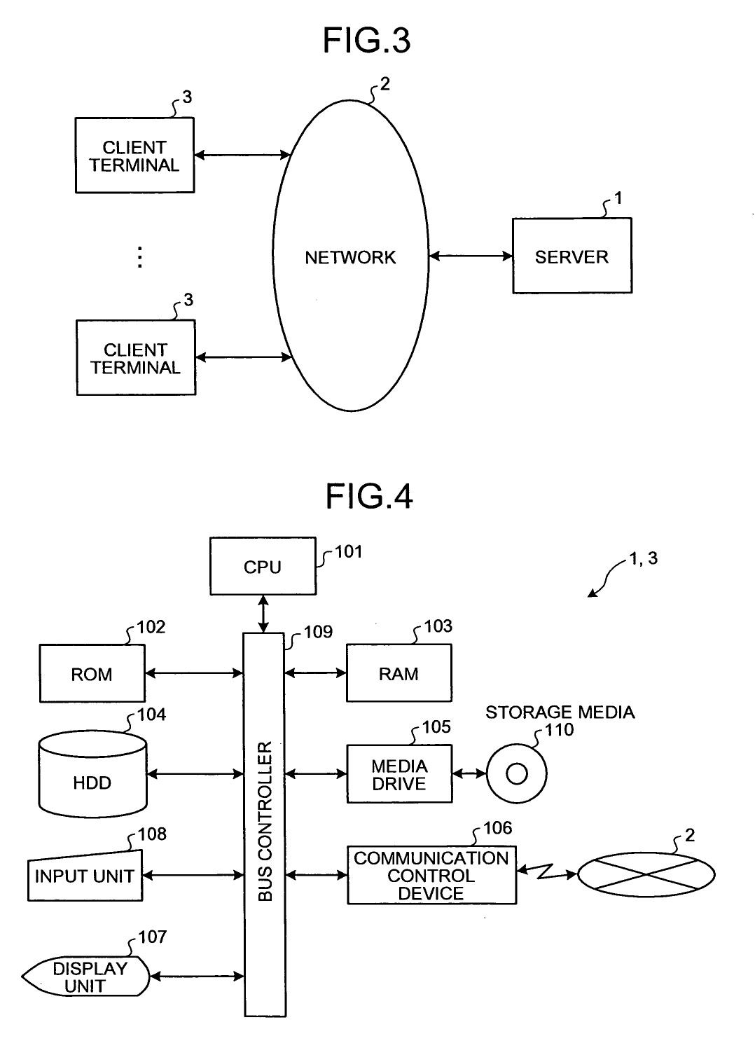

An embodiment of the present invention is explained below in detail. FIG. 3 is a schematic of a content displaying system according to the embodiment. The content displaying system is a client-server system in which a server computer (hereinafter, “server”) 1 is connected to a plurality of client computers (hereinafter, “client terminal”) 3 via a network 2. The network 2 can be a local area network (LAN) or any other network. The client terminal 3 can be a common personal computer.

FIG. 4 is a hardware structure of the server 1. It is assumed here that the client terminals 3 have the same hardware structure as that of the server 1. Each of the server 1 and the client terminal 3 includes a central processing unit (CPU) 101, a read only memory (ROM) 102, a random access memory (RAM) 103, a hard disk drive (HDD) 104, a media drive 105, a communication control device 106, a display unit 107, and a input unit 108. The CPU 101 processes information. The ROM 102 stores therein computer programs such as a basic input output system (BIOS). The RAM 103 rewritably stores therein various data. The HDD 104 is used to store therein various databases and computer programs. The media drive 105 is a drive device, such as a compact-disk read-only memory (CD-ROM) drive, for saving information, delivering or obtaining information that has been stored on a storage media 110. The communication control device 106 controls communications performed between the server 1 and other computers via the network 2. In other words, the server 1 can send or receive data to the other computers under the control of the communication control device 106. The display unit 107 is used for displaying processes or results of processing for an operator, and it can be a cathode ray tube (CRT) or a liquid crystal display (LCD). The input unit 108 is used to input data and/or instructions, and it can be a keyboard or a pointing device such as a mouse. A bus controller 109 bridges data to be transmitted between these units to carry out operation.

When an operator turns ON the power of the server 1, the CPU 101 boots a loader, which is a computer program present in the ROM 102, reads an operation system (OS), which controls hardware and software of the server 1, from the HDD 104 into the RAM 103, and then boots the OS. The OS boots an application program, reads or saves information, according to the operator's operation. Windows™ and UNIX™ are examples of the OS. The application program runs on the OS. An application program is not limited to one operated on a certain OS, but also can be a computer program that assigns part of execution of processing described below to the OS, or can be included in part of a group of computer program files that constitute certain application software or the OS.

A dictionary-content processing program is stored in the HDD 104 of the server 1 as the application program. The HDD 104 serves as a storage media to store the dictionary-content processing program. On the other hand, a dictionary-content input-output program is stored in the HDD 104 of the client terminal 3 as the application program. The HDD 104 serves as a storage media to store the dictionary-content input-output program.

The application program can be installed in the HDD 104 of the server 1 or the client terminal 3 by reading the application program from the storage media 110. The storage media 110 can be an optical disk such as CD-ROM or DVD, an optical magnetic disk, a magnetic disk such as a flexible disk, a semiconductor memory, or the like. On the other hand, the application program can be received from an external source via the communication control device 106.

When the dictionary-content processing program present in the HDD 104 of the server 1 is booted, the CPU 101 of the server 1 executes various processing according to the dictionary-content processing program to control each unit intensively. When the dictionary-content input-output program present in the HDD 104 of the client terminal 3 is booted, the CPU 101 of the client terminal 3 executes various processing according to the dictionary-content input-output program to control each unit intensively. Among various processing to be executed by the CPU 101 in the server 1 and the client terminal 3, the processing that are relevant to the embodiment are explained below in detail.

The dictionary-content input-output program boot in the client terminal causes the client terminal 3 to receive data from the server 1 and output the data received to the display unit 107 via a graphical user interface (GUI). Moreover, dictionary-content input-output program causes the client terminal 3 to receive data or a command resulting from an operation or a setting instruction performed by an operator on a screen displayed on the display unit 107 via the input unit 108 and to transmit the data or the command to the server 1.

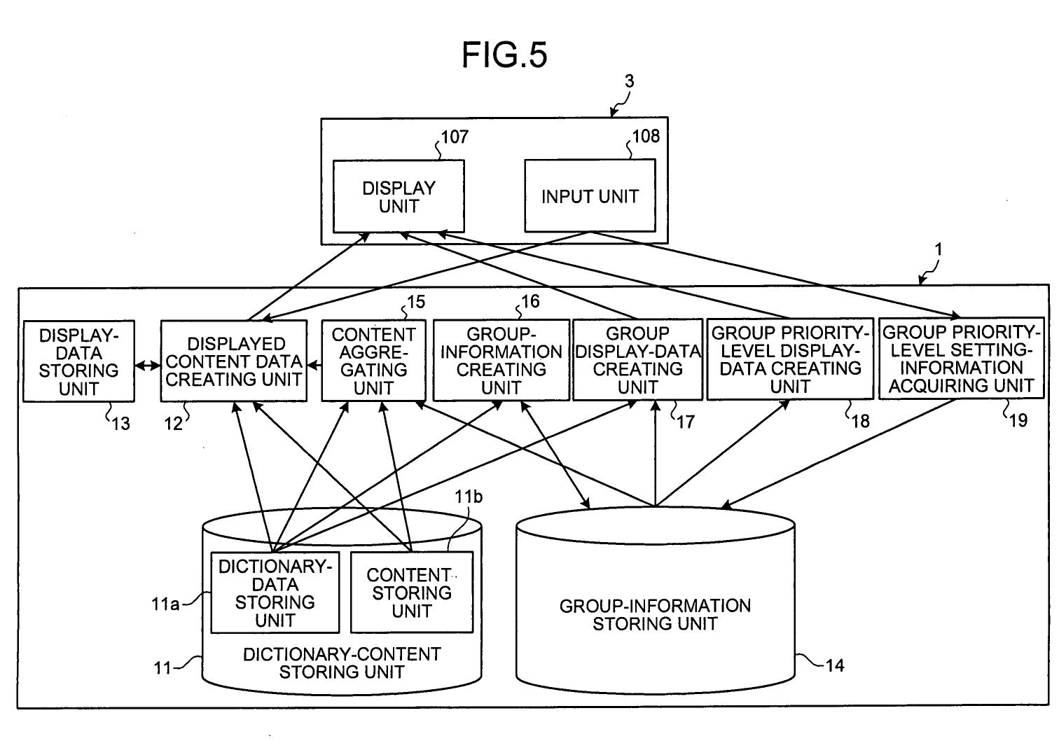

FIG. 5 is a detailed functional diagram of the server 1 and the client terminal 3. The server 1 includes a dictionary-content storing unit 11, a displayed content data creating unit 12, a display-data storing unit 13, a group-information storing unit 14, a content aggregating unit 15, a group-information creating unit 16, a group display-data creating unit 17, a group priority-level display-data creating unit 18, and a group priority-level setting-information acquiring unit 19.

The dictionary-content storing unit 11 includes a hierarchical database. The hierarchical database has a hierarchical structure in which a plurality of classes is hierarchically associated. Each of the classes inherits all properties belonging to a class in an upper layer of the each class. The dictionary-content storing unit 11 includes a dictionary-data storing unit 11a and a content storing unit 11b. The dictionary-data storing unit 11a stores therein information of the classes that constitute the hierarchical structure, information of parent-child relation between the classes, and dictionary data configured from information of each property item defined in the each class. Content described based on a set of properties belonging to a subject class is registered into the subject class. The content storing unit 11b stores therein content by associating with dictionary data present in the dictionary-data storing unit 11a.

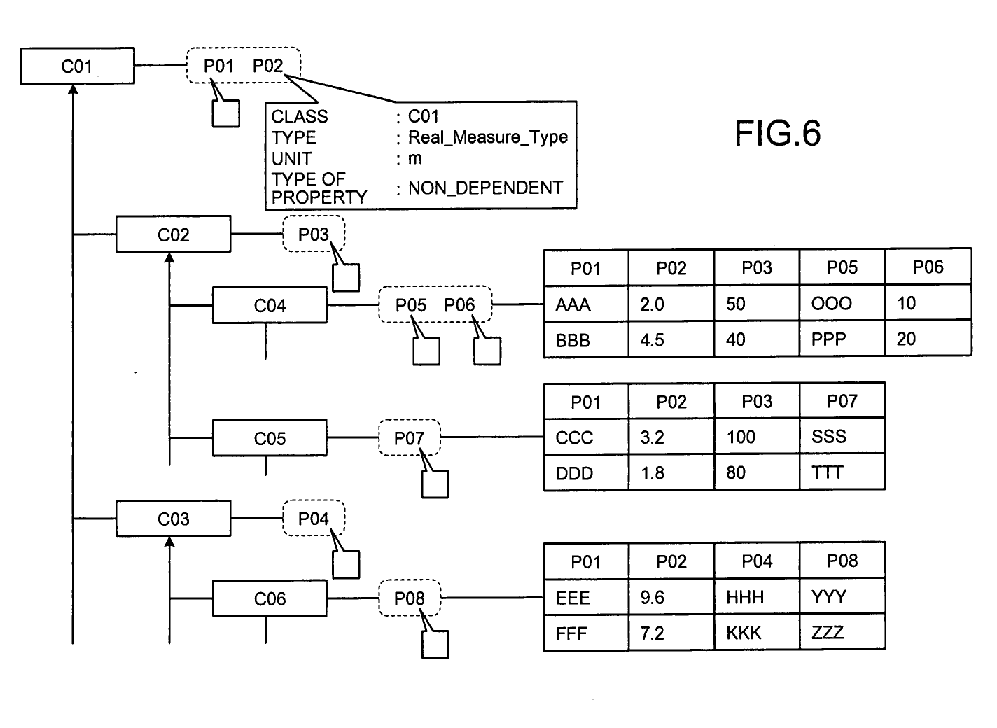

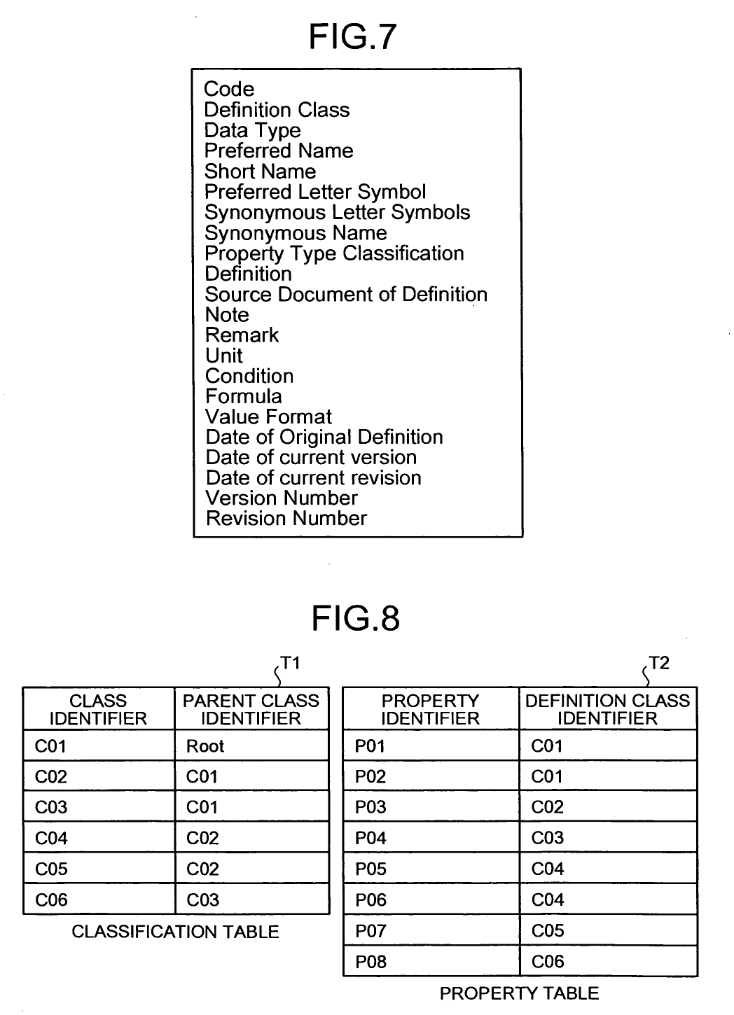

FIG. 6 is a schematic for systematically explaining a structure of a hierarchical database present in the dictionary-content storing unit 11. The hierarchical database follows the PLIB standard. In the hierarchical database, C01 to C06 denote classes, P01 to P08 denotes properties, and content of each of the classes is presented in each table. A solid arrow pointing from one class to another class indicates inheritance relation between the one class, which is a child class, and the other class, which is a parent class. A solid line connecting a class and a group of properties indicates belongingness of the properties defined in the class. A solid line connecting between each group of properties and each table indicates that the each table is content of a connected class. The class C01 is the highest level class in the example shown in FIG. 6, and the properties P01 and P02 are defined in the class C01. The classes C02 and C03 are child classes of the class C01. The child classes C02 and C03 have the properties of the class C01, which is their upper class, as well as own properties individually defined in the each class itself. Similarly, other classes also inherit to have properties defined in an upper class as well as self-defined own properties. Consequently, the lower the class is, generally the more properties the class has in a hierarchical database. Values of the properties defined in the each class are described in the each table of content, as well as values of the properties inherited from the upper class. Moreover, metadata of the properties P01 to P08 is expressed as a balloon. Metadata of a property are not limited to those shown in FIG. 6, but as shown in FIG. 7, metadata can be any schema defined for a property.

The each child class has a unique parent class in the example shown in FIG. 6. Multiple inheritance in which a class has a plurality of parent classes is included this data model.

FIG. 8 is an example of dictionary data in the dictionary-data storing unit 11a. The dictionary data is stored in the form of a table of a relational database (RDB). The classification hierarchy and the properties in FIG. 6 are presented in a classification table T1 and a property table T2 in FIG. 8. To simplify the explanation, T1 is configured only with an identifier of a class (class identifier) and an identifier of a parent class of the class (parent class identifier) as column items. When searching an upper class of a class, an identifier of a parent class is acquired with an identifier of the class as a key, and then an identifier of a further parent class of the parent class is acquired with an acquired identifier of the parent class as a key. By repeating this process recursively, all upper classes of the initial class can be entirely searched. When the class has more than one parent classes, the process can be performed for remaining one of parent classes. Similarly, to search lower classes, classes belonging to an acquired class as a parent class can be acquired. This allows upper classes and lower classes to be easily searched by referring the classification table T1 recursively. The property table T2 can be configured with an identifier of a class in which a property is defined (definition class identifier), and an identifier of the property (property identifier). Referring to the property table T2, information of a class in which a property is defined and which defines what kind of properties which are defined can be obtained.

Accordingly, the classification table T1 can be searched to acquire identifiers of all upper classes, and then the property table T2 is searched with the identifiers as a key, so that information of a property defined in the subject class and properties inherited from the upper classes can be easily obtained.

The structures of the classification table T1 and the property table T2 are not limited to those shown in FIG. 8. Some additional information can be put in those tables as required. Furthermore, if equivalent information can be obtained by searching, a table configuration does not have to conform to this example.

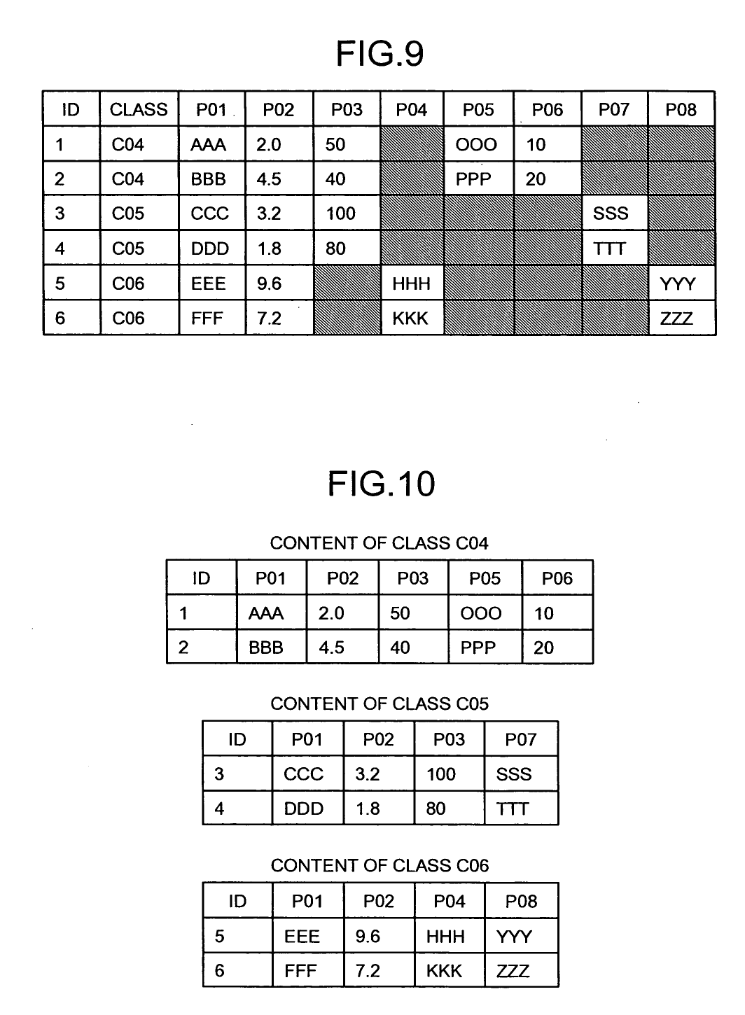

FIG. 9 is an example of content stored in association with the dictionary data in FIG. 8, when content that the content storing unit 11b stores therein is stored in the relational database. In the example shown in FIG. 9, to simplify the explanation, all content are stored in one table. A header of the table includes ID, which indicates an identifier for identifying content, class, which indicates a class describing the content, and property items. As examples of content, respective content of classes C04, C05, and C06 are described, and respective fields each of which presents a value of each property store respective values. When content of each class are presented in a table, a blank indicates a field provided for a value of a property that a class does not have. Such fields are presented with a shadow to distinguish those from the other fields in FIG. 9. A method of storing content does not have to be conformed to the example in FIG. 9. If equivalent information is present, configuration can be designed in any style, for example, in individual content data tables provided per class as shown in FIG. 10.

Next, the displayed content data creating unit 12 shown in FIG. 5 creates displayed content data to be displayed on the display unit 107 of the client terminal 3. The displayed content data is created from dictionary data and content extracted from the dictionary-content storing unit 11.

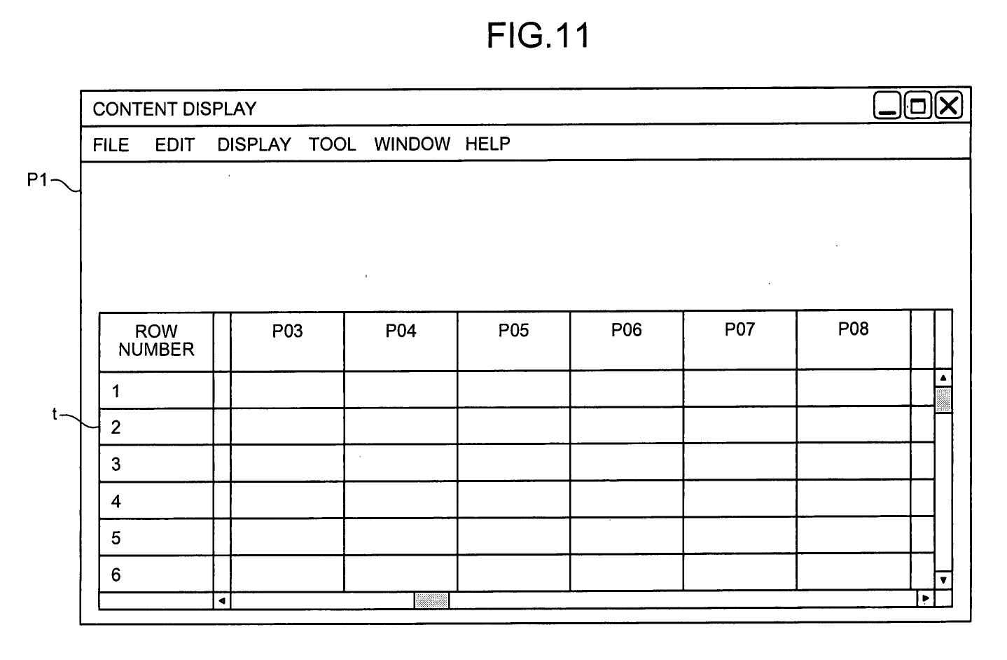

FIG. 11 is an example of a content data displaying screen P1 that is displayed on the display unit 107 of the client terminal 3. The display unit 107 of the client terminal 3 displays a table t on the content displaying screen P1. The table t is provided in a matrix form with a header including property items. A list of content in a class, which can be specified by an operator through a query statement, is displayed in the table t. Property items to be displayed does not have to include all of the properties belonging to the class specified by the operator, and a range of the property items can be narrowed by specifying items in advance. On the table t, using the input unit 108 of the client terminal 3, the operator can drag a certain property in the header, and move it to the left or the right to another property item, and drop the property there thereby changing the display position of the property. Information indicative of the change in the display position of the property is transmitted from the client terminal 3 to the displayed content data creating unit 12 of the server 1. The displayed content data creating unit 12 then creates displayed content data based on acquired information.

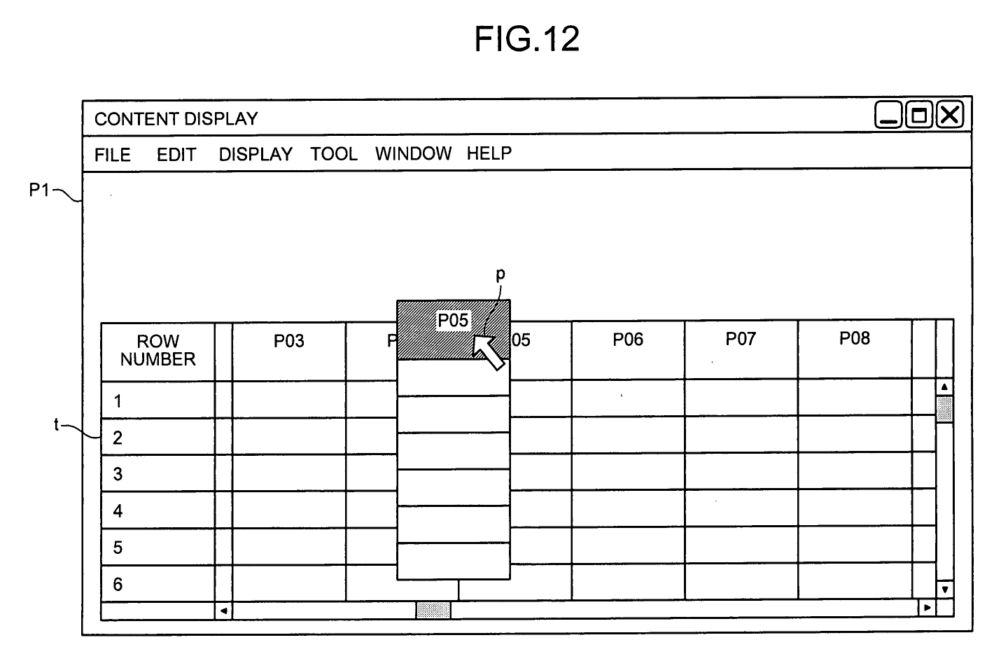

FIG. 12 is schematic for explaining the operation performed by an operator when moving a property in the table t from one place to another. In FIG. 12, a property item selected by the operator is presented with shadow. During drag processing, a column or a row of the selected property item is visually displayed like being attached to a pointer p as shown in FIG. 12, the operator can move the property item intuitively.

Thus, the displayed content data created by the displayed content data creating unit 12 for the operator is stored in the displayed data storing unit 13. The displayed data storing unit 13 stores therein order of property items, which is synchronized with the table t displayed on the display unit 107 of the client terminal 3.

The reason for allowing movability of property items is as follows: order of the property items displayed on the table t is usually determined according to a predetermined order or order of moments at each of which each of the property items is read, unless otherwise the operator specifies another order with a query statement; consequently, when the properties to be viewed are arranged discretely in displayed content data, the operator needs to move properties in order to place the properties to be viewed into an arrangement adjacent one another.

The content aggregating unit 15 aggregates values of property items based on information of a group of property items (hereinafter, “group information”) present in the group-information storing unit 14, when a property item is selected and moved on the table t displayed on the content displaying screen P1 displayed on the display unit 107 of the client terminal 3. By aggregating content data of property items, when the operator changes a displayed position of a subject property item on the table t displayed on the content displaying screen P1 displayed on the display unit 107 of the client terminal 3, a displayed position of another property (group) belonging to the same group as the subject property item can be changed together with the subject property item. Specifically, when a large number of properties are to be displayed on the table t, through the drag processing, the operator can place properties to be viewed into an arrangement adjacent one another, or can move a certain property item to the top of the table, thereby improving a grasp at sight and usability. Moreover, as number of times of searching or moving a property item decreases, a workload of the operator is reduced.

In other words, when the operator changes a displayed position of a property item on the table t displayed on the content displaying screen P1 displayed on the display unit 107 of the client terminal 3, the displayed content data creating unit 12 acquires aggregated values of property items from the content aggregating unit 15 to create displayed content for displaying acquired content at a moved destination of the subject property of which the displayed position has been changed.

When a property belongs to a plurality of groups, order of properties displayed after moving varies depending on which group is to be referred first and subsequently. Furthermore, depending on operations or content to be viewed, an operator would desire to move a selected property not together with a linked property in the same group. In this case, it is better that the operator can choose which group of the selected property is to be reflected to movement when moving the selected property. Moreover, if the operator can simultaneously determine order of the groups to be reflected, a display layout can be provided so as to satisfy requirements of the operator, and the same to each of the other operators.

Therefore, according to the embodiment, an operator can predetermine order of groups of a selected property and order according to system recommendation. This assists an operator with poor knowledge about dictionary data for operations and viewing. Details are described below.

The group-information storing unit 14 is a relational database (RDB) for storing group information of a property and a priority level. Such group information of a property is created by the group-information creating unit 16. More specifically, the group-information creating unit 16 acquires metadata of each property from the dictionary-data storing unit 11a in the content storing unit 11b (metadata acquiring unit), and creates group information that properties are automatically or semi-automatically grouped with information extracted from the metadata (grouping unit).

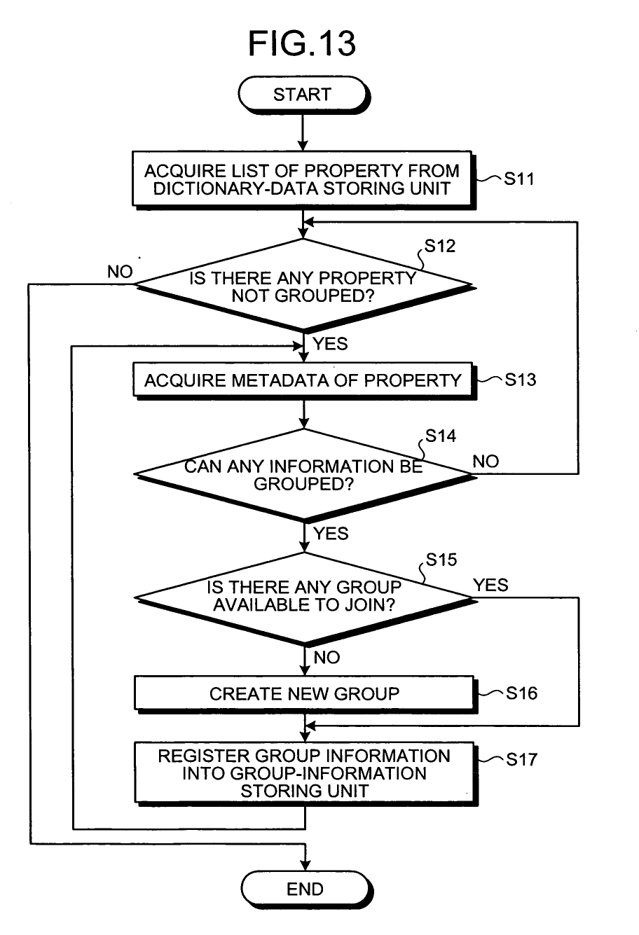

FIG. 13 is a flowchart of a process for creating group information in the group-information creating unit 16. The group-information creating unit 16 acquires a list of properties from the dictionary-data storing unit 11a of the dictionary-content storing unit 11 (step S11), and determines whether there is any property not being grouped (step S12).

When the group-information creating unit 16 determines that there is a property not being grouped (step S12, Yes), the group-information creating unit 16 acquires metadata of each property from the dictionary-data storing unit 11a (step S13). Subsequently when there is information available to be grouped (step S14, Yes) and when there is no group available to join (step S15, No), a new group is created (step S16), group information is registered into the group-information storing unit 14 (step S17), and then the processing returns to step S13. On the other hand, when there is information available to be grouped (step S14, Yes) and when there is a group available to join (step S15, Yes), the processing goes to step S17, and group information is registered into the group-information storing unit 14.

The steps S13 to S17 are repeated until it is determined that there is no property not being grouped (step S12, No).

When it is determined that there is no property that has not been grouped (step S12, No), the processing is terminated.

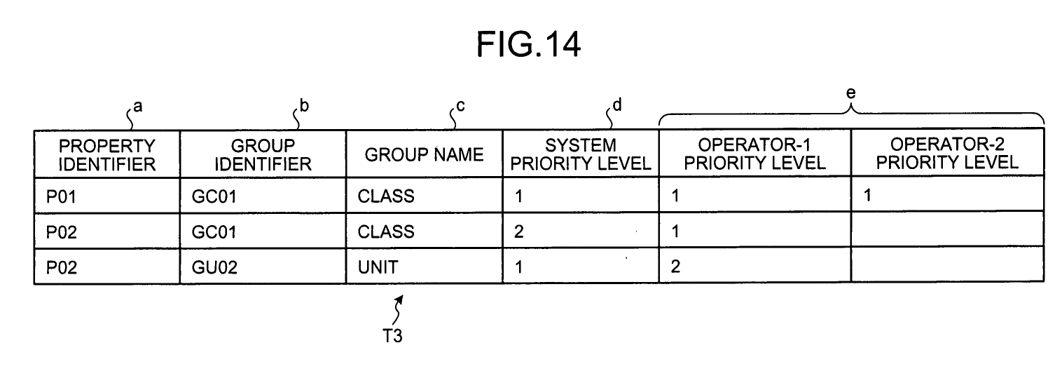

FIG. 14 is an example of a table T3 registered in the group-information storing unit 14. The table T3 maps a property, its group, and its priority. The table T3 includes items a to e. The item a is a property identifier, which uniquely identifies a property. The item b is a group identifier, which uniquely identifies a group. The item c is a group name, which presents a name of the group identified with the item b group identifier. The item d is a system priority level, which indicates a priority level of the group according to the system recommendation. The item e is an operator priority level, which indicates a priority level of the group determined by each operator. A series of data in a row constitutes a record to be stored. In the example shown in FIG. 14, a priority level of a group for a property is assigned to every group of the property. Precisely, a priority level of each group determined for a property is independent from a priority level of the each group determined for another property. The table shown in FIG. 14 is just an example, and number of tables, and types and numbers of component items in the table are not limited to this example as long as a table satisfies similar conditions. Furthermore, the priority levels in the example are shown in natural numbers, and the smaller the value is, the higher the priority level is, however, it is not limited to this if the similar meaning can be indicated.

In the example shown in FIG. 14, the properties P01 and P02 belong to a group CLASS that has a group identifier GC01. Focusing on a group GC01, a priority level of the system recommendation is “1” in the property P01, while it is “2” in the property P02. This means that, when acquiring a priority level of the group GC01 from the property P01, priority level “1” is returned; while when acquiring a priority level of the group from the property P02, priority level “2” is returned. When an operator determines a priority level of the group as presented in operator-1 priority level in the item e, a setting by the operator is given priority, unless the operator choose the priority level according to the system recommendation. By contrast, as presented in operator-2 priority level, when an operator does not determine priority level of the group, the priority level according to the system recommendation is chosen.

As well as storing a setting per operator, storing setting information per group to which each operator belongs, when an operator inquires, the setting information of a group to which the operator belongs can be returned.

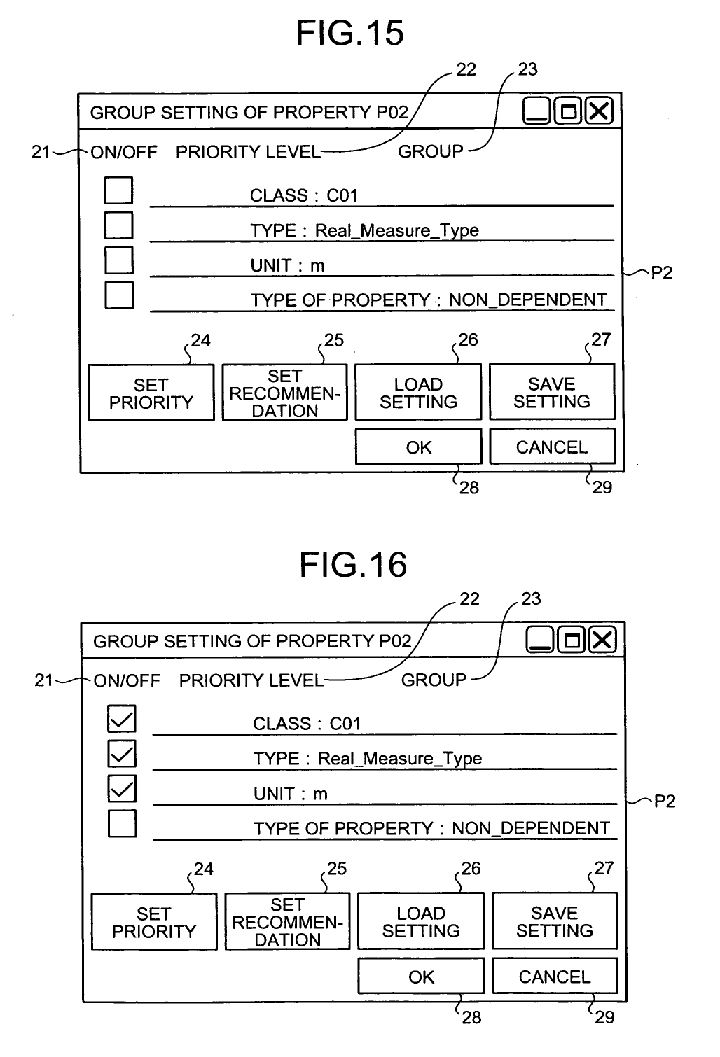

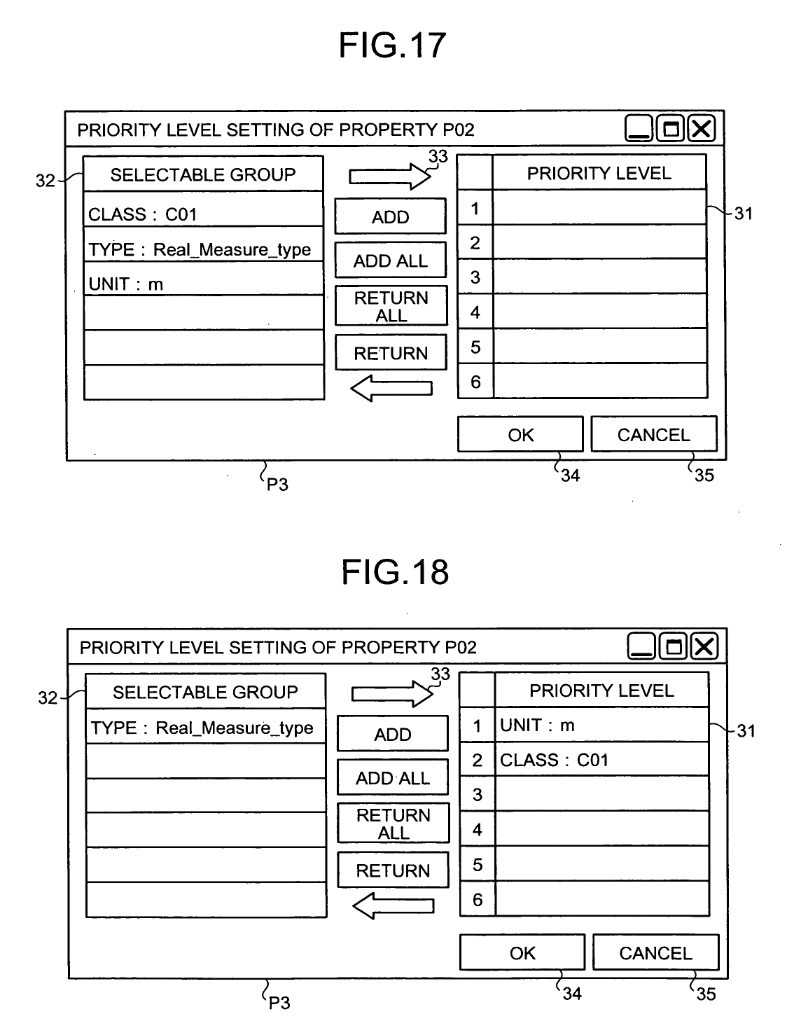

The group display-data creating unit 17 acquires group information of a property from the group-information storing unit 14 to create group display data for outputting a group setting screen P2 shown in FIG. 15 on the display unit 107 of the client terminal 3. The group setting screen P2 provides an interface for an operator to operate setting groups. The group priority-level display-data creating unit 18 acquires group information and information of its priority level from the group-information storing unit 14 to create group priority-level display data for outputting a priority-level setting screen P3 shown in FIG. 17 on the display unit 107 of the client terminal 3. A priority level to each group is set or presented on the priority-level setting screen P3. Thus, setting information about a group and its priority level determined by an operator based on a screen displayed on the display unit 107 of the client terminal 3 is transmitted to the group priority-level setting-information acquiring unit 19. The group priority-level setting-information acquiring unit 19 acquires the information determined by the operator to store it into the group-information storing unit 14.

The process for setting a group and determining a priority level of the group is explained below with reference to FIGS. 15 to 19.

FIG. 15 is an example of the group setting screen P2 displayed on the display unit 107 of the client terminal 3. The group setting screen P2 is called from the content displaying screen P1 in FIG. 11. The group setting screen P2 includes a applied-group switching unit 21, a set priority-level displaying unit 22, a group-information displaying unit 23, a set priority button 24, a set recommendation button 25, a load setting button 26, a save setting button 27, and buttons 28, 29. The applied-group switching unit 21 switches whether each group to which a selected property belongs is to be moved together. The set priority-level displaying unit 22 displays a set priority level. The group-information displaying unit 23 presents information of a group. The set priority button 24 is for displaying the priority-level setting screen P3 that serves setting of a group priority level. The set recommendation button 25 is for acquiring setting details according to the system recommendation from the group-information storing unit 14 to display them. The load setting button 26 is for acquiring setting details predetermined and registered by an operator from the group-information storing unit 14. The save setting button 27 is for storing setting details into the group-information storing unit 14. The buttons 28, 29 are for applying or canceling setting details.

The applied-group switching unit 21 is composed of check boxes that can be checked with the input unit 108 of the client terminal 3. Each check box is associated with a group displayed on the same row. The set priority-level displaying unit 22 displays a determined priority level of each group. Priority levels to be displayed on the set priority-level displaying unit 22 are limited to groups that are checked in the check box. The group-information displaying unit 23 displays all groups to which the selected property belongs. Information to be referred for the group setting screen P2 is obtained from the group-information storing unit 14.

When an operator changes a displayed position of a selected property, the operator checks a check box of a group to be subjected on the group setting screen P2. In the example shown in FIGS. 15 and 16, a situation is shown where class: C1, Type: Real_Measure_Type, and Unit: m is selected as subject for grouping, and the operator has checked check boxes corresponding to respective items. In FIG. 16, a priority level is not displayed on the set priority-level displaying unit 22, therefore a priority level has to be set for each group with a check mark. To set a priority level for theses groups, the operator checks one or more groups, and then presses the set priority button 24.

FIG. 17 is an example of the priority-level setting screen P3, which is displayed after the set priority button 24 is pressed on the screen in FIG. 16. The priority-level setting screen P3 is a screen displayed on the display unit 107 of the client terminal 3 for setting priority levels of the groups that are checked on the group setting screen P2. The priority-level setting screen P3 includes a priority-level displaying unit 31, a selectable-group displaying unit 32, a priority-setting operating unit 33, and buttons 34, 35. The priority-level displaying unit 31 displays groups of which priority levels are provisionally set, in order of priority level. The selectable-group displaying unit 32 displays a list of groups of which priority levels are not provisionally set. The priority-setting operating unit 33 includes an arrangement of buttons for transferring a group item between the priority-level displaying unit 31 and the selectable-group displaying unit 32 for setting priority levels. The buttons 34 and 35 are for respectively approving and canceling setting details.

In each of the priority-level displaying unit 31 and the selectable-group displaying unit 32, a plurality of groups can be selected at once with the input unit 108 of the client terminal 3.

The priority-setting operating unit 33 includes four buttons, namely, add, add all, return all, and return. The add button is for adding one or more group items selected in the selectable-group displaying unit 32 to the priority-level displaying unit 31. An added group is deleted from the list on the selectable-group displaying unit 32. A position of a selected group item added into the priority-level displaying unit 31 is at the lowest in displayed groups. When a plurality of group items is selected, the group items are added in order in which the group items are displayed in the selectable-group displaying unit 32. The add all button is for adding all of the group items displayed on the selectable-group displaying unit 32 to the priority-level displaying unit 31. Precisely, this button serves the same function as the add button is pressed when all of the group items in the selectable-group displaying unit 32 are selected. The return all button and the return button function in reverse to the add all button and the add button respectively, precisely, serves for returning groups selected in the priority-level displaying unit 31 to the selectable-group displaying unit 32

FIG. 18 is another example of the priority-level setting screen P3, where a unit: m group and a class: C01 group displayed in the selectable-group displaying unit 32 shown in FIG. 17 are added into the priority-level displaying unit 31 in this order. When all of the group items are added into the priority-level displaying unit 31, and an OK button is then pressed, priority levels set on the priority-level setting screen P3 are applied to respective groups. In contrast, as shown in the example in FIG. 18, when a group item is still left in the selectable-group displaying unit 32, and the OK button is then pressed, the system automatically adds group items displayed in the selectable-group displaying unit 32 from the top into the priority-level displaying unit 31 to apply priority levels.

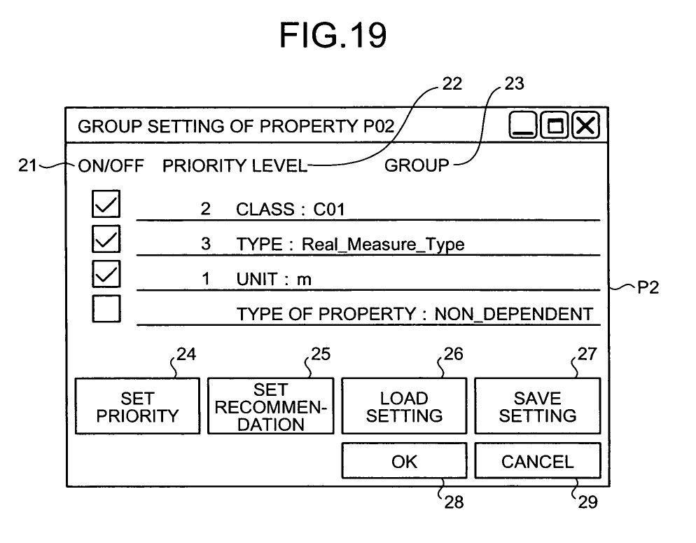

FIG. 19 is an example of the group setting screen P2 after applying the priority set in the example FIG. 18. Respective group priority levels of unit: m and class: C01, which are set by the operator in the example FIG. 18, and a group priority level of type: Real_Measure_Type, which is automatically set by the system because the operator dose not set it, are displayed on the set priority-level displaying unit 22.

Finally, when the OK button 28 is pressed on the group setting screen P2, the setting of groups to be applied of the property and their respective priority levels is then applied to end the operation. When the cancel button 29 is pressed, the setting details that have been operated are cancelled to end the operation.

When the operator presses the set recommendation button 25 on the group setting screen P2, the group setting information according to the system recommendation is acquired from the group-information storing unit 14 to display group information and its priority level on the group setting screen P2. Alternatively when the operator presses the load setting button 26, the group information of the property and its priority level predetermined and registered by the operator is acquired to display those on the group setting screen P2. Otherwise when the operator presses the save setting button 27, the setting details displayed on the group setting screen P2 is transmitted to the group priority-level setting-information acquiring unit 19. The group priority-level setting-information acquiring unit 19 stores therein the setting details into the group-information storing unit 14 as setting information for the operator.

Due to such an operation, decision of grouping and a group priority level can be set. Moreover, the information of priority level set by the operator is associated with the operator to be stored in the group-information storing unit 14.

The embodiment relates to a case where parameters such as decision of grouping and a group priority level are not predetermined. However, these parameters can be set in advance, or a setting recommended by the system can be presented on the group setting screen P2. According to the embodiment, the operator sets decision of each grouping and its priority level on the group setting screen P2. However, to move a selected property item together with a linked property item, the group setting screen P2 of the property can be presented on the display unit 107 of the client terminal 3 while or after moving to decide grouping and to apply or correct a priority level while or after moving.

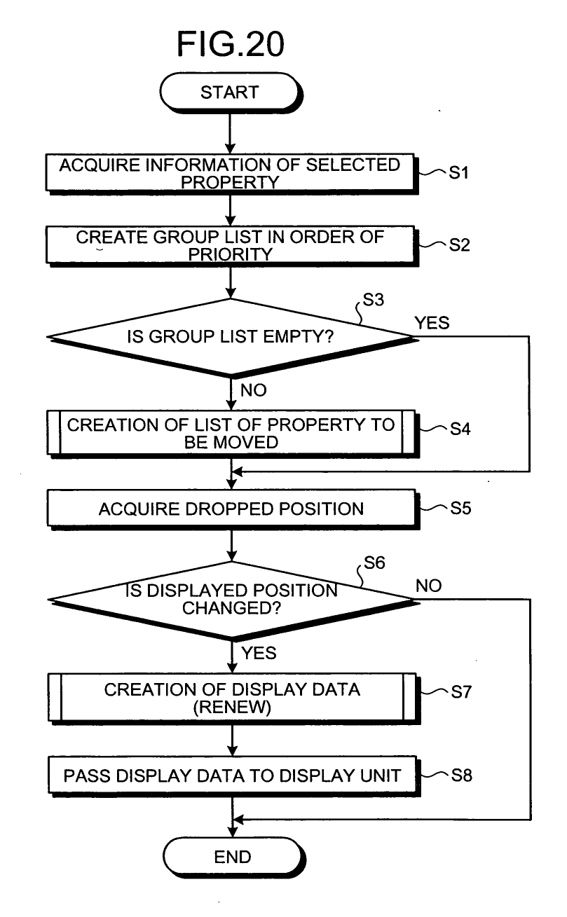

A process for moving together with a linked property item is explained with reference to a flowchart shown in FIG. 20.

First of all, when an operator drags a property item on the table t displayed on the content displaying screen P1 of the display unit 107 of the client terminal 3, information of a selected property item is notified to the displayed content data creating unit 12 (step S1). The displayed content data creating unit 12 acquires an identifier of the property item, and using it as a key, and then acquires groups to which the property item belongs from the group-information storing unit 14 in order of priority (step S2).

When one or more piece of group information is contained in an acquired group list (step S3, No), the displayed content data creating unit 12 acquires a list of properties to be moved using the acquired group list (step S4). By contrast, when the group list is empty (step S3, Yes), the processing goes to step S5 without acquiring the list of properties to be moved.

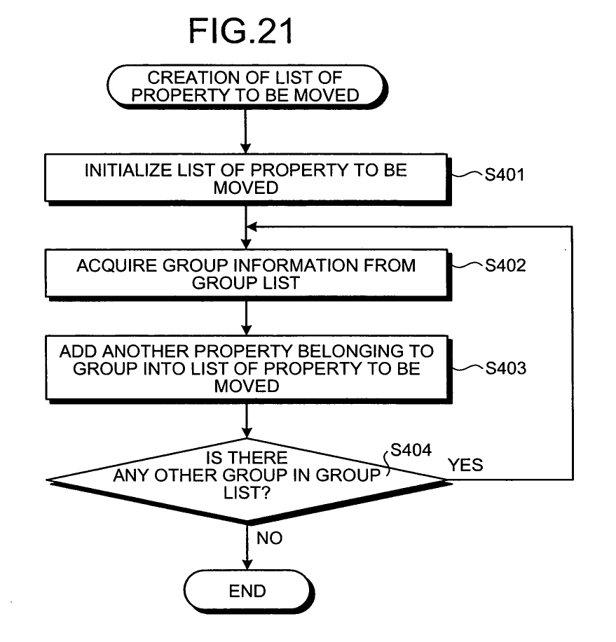

FIG. 21 is a detailed flowchart of the step S4 shown in FIG. 20. First of all, the list of properties to be moved for storing property items to be moved by following to a selected property is initialized (step S401). Group information is then acquired in order from the top of the group list sorted in priority order in step S2 (step S402). Using an acquired group identifier as a key, property items belonging to the group is acquired from the group-information storing unit 14 to be added to the list of properties to be moved (step S403). Among the acquired property items, the selected property, a property already added to the list of properties to be moved, and a property of which item is not included in the table displayed on a display device 2 are not added. After that, when any unprocessed group is left in the group list (step S404, Yes), the processing goes back to step S402 to continue processing. When processing of all groups is finished (step S404, No), the process for storing properties into the list of properties to be moved is ended, and the list of properties to be moved having created is passed to the displayed content data creating unit 12.

Returning to the explanation of FIG. 20, in step S5, when the operator drops the property item dragged with the input unit 108 of the client terminal 3, an inserted position when dropped, a coordinate of a pointer on the table, and a displayed region of content are notified to the displayed content data creating unit 12. The inserted position when dropped indicates information of a property item to which the property item is moved on the left or the right, which is required for sorting by moving property items. The coordinate of the pointer on the table and the displayed region of content are required to re-display displayed content data renewed by moving on the table.

In such drag and drop processing in step S5, when displayed positions are equal before and after dragging and dropping, it is treated as the property item is not moved, then the processing is ended (step S6, No). By contrast, when displayed positions are different before and after dragging and dropping (step S6, Yes), the property item is moved, so that the processing goes to a process for renewing displayed content data.

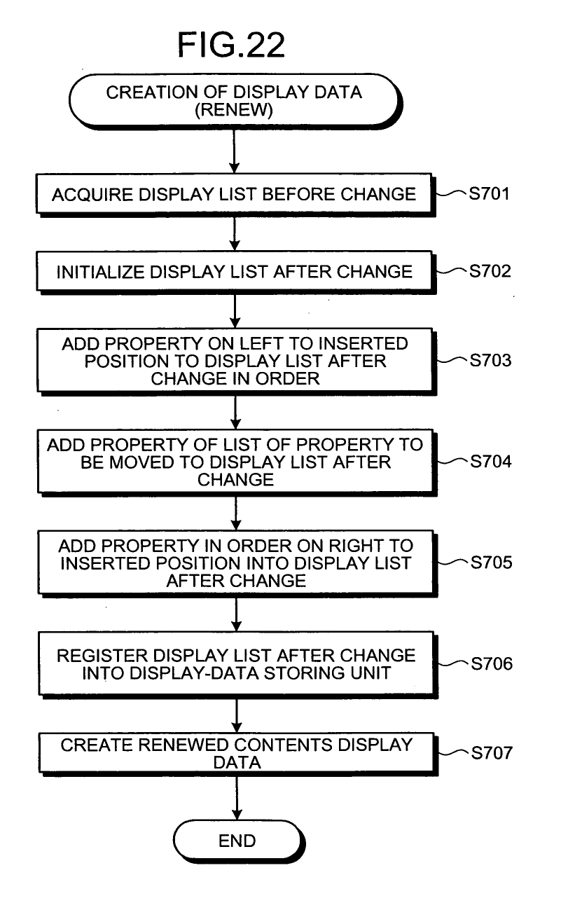

FIG. 22 is a flowchart of a process for creating (renewing) displayed content data in step S7. The displayed content data creating unit 12 acquires, at first, a display list present in the display-data storing unit 13 as a display list before change (step S701), and initializes a display list after change for storing order of the property items after moving (step S702). Next, the displayed content data creating unit 12 acquires properties displayed on the left to the inserted position in order from the top. Properties that are in the list of properties to be moved are to be inserted as linked to the inserted selected property, so that in this stage, only properties that are not included in the list of properties to be moved are added to the display list after change (step S703). The displayed content data creating unit 12 then acquires properties in the list of properties to be moved, and adds only properties included in the display list before change to the display list after change (step S704). The displayed content data creating unit 12 then acquires properties displayed on the right to the inserted position in order. Among those properties, because properties included in the list of properties to be moved are already added to the display list after change, only properties that are not included in the list of properties to be moved are added to the display list after change (step S705). The display list after change is stored into the display-data storing unit 13 (step S706). Finally, the displayed content data creating unit 12 creates displayed content data in which the property items are sorted in order of the display list after change (step S707).

Finally in step S8, the displayed content data creating unit 12 passes renewed displayed content data to the display unit 107 of the client terminal 3. The display screen displays content in a table on the content displaying screen P1 based on acquired displayed content data. On the table, dropped property items are displayed on the coordinate from a coordinate of the pointer dropped by the operator. By displaying the same content on the table as the displayed region of the content when dropped, the operator can view content in the same range after the properties are moved.

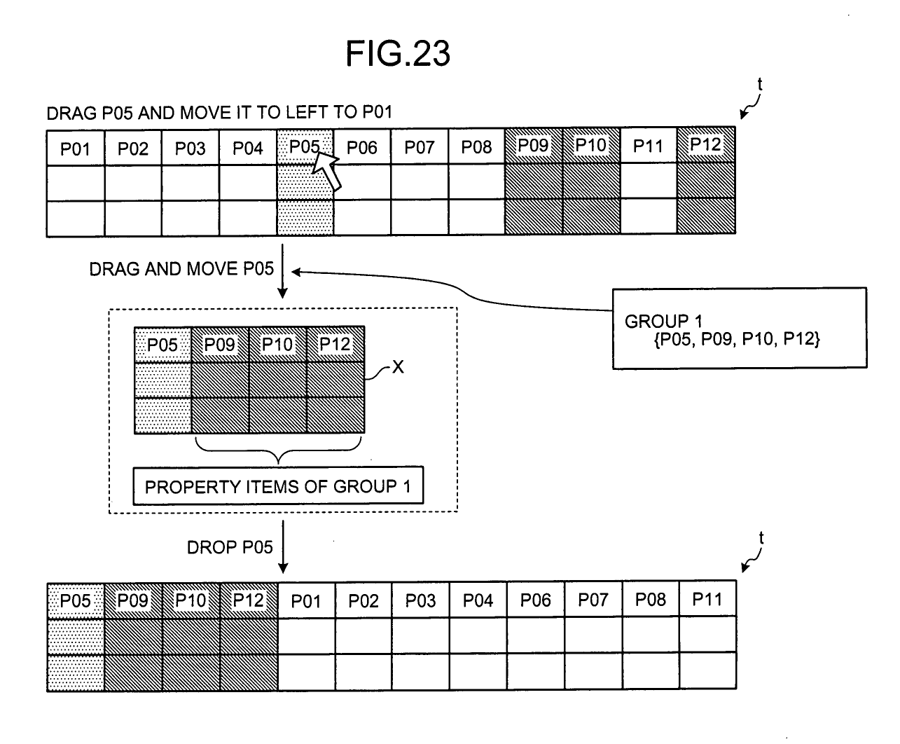

FIG. 23 is a schematic for explaining configuration of the table t before and after the operator moves the property item P05 to the left of the property item P01 on the table t displayed on the content displaying screen P1. In this example, the property item P05 belongs to the same group as the property items P09, P10, and P12. Accordingly, when an operator drags the property item P05, the property item P05 moves as linked to the three property items as shown as X in FIG. 23. When the property item P05 is dropped on the left to the property item P01, the property items P09, P10, and P12 are also moved together to the left to P01 in like manner, as well as the property item P05 selected by the operator.

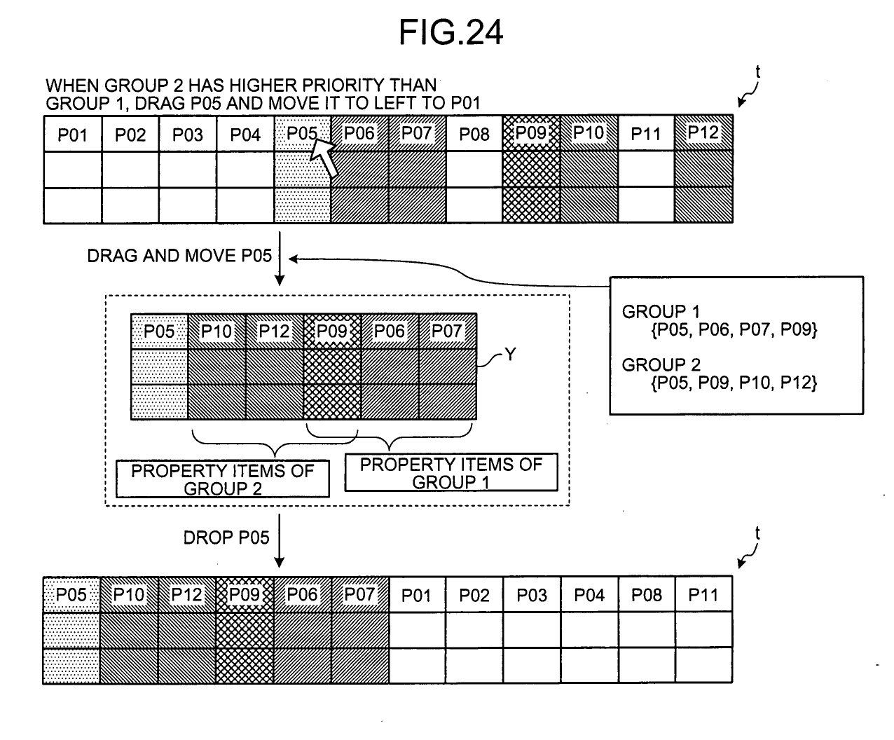

FIG. 24 is a schematic for explaining a case where a property item selected by the operator belongs to a plurality of groups, under the similar environment to that in FIG. 23. In FIG. 24, the property item P05 selected by the operator belongs to a group 1 that includes P06, P07, and P09 as well as P05, and to a group 2 that includes P09, P10, and P12 as well as P05. Precisely, the property item P09 belongs to the both groups. The group 2 has a higher priority than the group 1. Accordingly, when an operator drags the property item P05, the system acquires group information and priority level information of the property. The property items of the groups 2, P10, p12, and P09 are linked to the property item P05 at first. The property items of the group 1 are then linked. As shown as Y in FIG. 24, P09 is already linked, so that the rest of property items, P06, and P07 are linked. After that the operator drops the property item P05 onto the left next to the property item P01 similarly to FIG. 23, the other properties are automatically moved to be displayed in a linked state.

Thus, metadata of the properties defined according to a predetermined format. Under an environment that information of the properties is described, the metadata of the properties are extracted to be grouped automatically or semi-automatically. When an operator changes a displayed position of a property item on GUI, the displayed position can be changed by linking the subject property with another property (other properties) belonging to the same group as the subject property

In the examples in FIGS. 23 and 24, for the purpose of explaining in the drawings, headers of the selected property item and the property items belonging to the respective groups are shown with a background of a shadow, however, the headers of the property items belonging to the respective groups can be displayed with a colored background with respective colors assigned to the groups. A header of a property item belonging to a plurality of groups can be divided into a plurality of regions to be colored with respective colors of the groups. Alternatively, the header can be colored with only a color of a group with the highest priority. Moreover, a color selected by an operator can be assigned.

Thus, according to the system of the embodiment, an operator can easily operate to aggregate values of a subject property and of another property related to the subject property to reduce a workload of the operator. Particularly, by grouping properties based on their metadata in a hierarchical database in which a schema of the properties is defined, the operator can easily operate to move a subject property and of another property related to the subject property together.

Moreover, when changing a displayed position of a property, the operator can move a displayed position of the property related to the subject property close to the subject property, thereby reducing a workload of the operator for changing displayed positions of the properties. Furthermore, when an operator has a poor knowledge about dictionary data, a property automatically recommended by the system can be displayed close to the subject property when a displayed position of a property is changed, thereby preventing a related property from being missed.

In examples according to the embodiment, a client-server system is assumed, however, the present invention is not limited to this, and the embodiment can be carried out in a form of stand-alone system not connected to any network.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A dictionary-content processing apparatus comprising:
a dictionary-data storing unit that stores dictionary data defined based on a hierarchical data model in which an upper class inherits a property to a lower class;
a content storing unit that stores content described based on the dictionary data;
a metadata acquiring unit that acquires metadata of each property from the dictionary data;
a grouping unit that creates group information by grouping properties based on the metadata;
a group-information storing unit that stores the group information;
a displayed content data creating unit that searches the dictionary data present in the dictionary-data storing unit and the content present in the content storing unit to create displayed content data; and
a content aggregating unit that aggregates, when a property is selected on a content display screen based on the displayed content data, values of selected property based on group information relating to the selected property present in the group-information storing unit.

2. The apparatus according to claim 1, wherein, when a displayed position of a property is changed on the content display screen, the displayed content data creating unit acquires aggregated values of displayed position changed property from the content aggregating unit and creates displayed content data for displaying acquired content on a moved position of the displayed position changed property.

3. The apparatus according to claim 2, further comprising a group display-data creating unit that acquires the group information present in the group-information storing unit and creates group display data for creating a group setting screen to be displayed for an operator to operate group setting based on acquired group information, wherein
a decision whether a property in each group to which a selected property belongs is to be moved together can be switched on the group setting screen.

4. The apparatus according to claim 2, further comprising a group priority-level display-data creating unit that acquires the group information present in the group-information storing unit and priority of acquired group information and creates group priority-level display-data for displaying a priority setting screen for setting and presenting a priority level of each group, wherein
a priority level of each group to be applied can be set on the priority setting screen.

5. The apparatus according to claim 4, further comprising a group-priority setting-information acquiring unit that acquires a priority level of each group to be applied set via the priority setting screen and stores acquired priority level into the group-information storing unit, wherein
when a property is selected on the content display screen, the content aggregating unit extracts a priority level of each group present in the group-information storing unit in relation to selected property, and acquires information of a group to which the property belongs from the group-information storing unit and aggregates values of the property.

6. The apparatus according to claim 3, wherein, during or after movement of a displayed position of a property on the content display screen, a decision of moving together with another property and a priority level of another property can be determined.

7. A system for displaying content comprising:
a dictionary-data storing unit that stores dictionary data defined based on a hierarchical data model in which an upper class inherits a property to a lower class;
a content storing unit that stores content described based on the dictionary data;
a metadata acquiring unit that acquires metadata of each property from the dictionary data;
a grouping unit that creates group information by grouping properties based on the metadata;
a group-information storing unit that stores the group information;
a displayed content data creating unit that searches the dictionary data present in the dictionary-data storing unit and the content data present in the content storing unit to create displayed content data;
a display unit that displays a content display screen based on the displayed content data;
an input unit which allows an operator to select a property displayed on the content display screen; and
a content aggregating unit that aggregates, when a property is selected on the content display screen, values of selected property based on group information of the selected property present in the group-information storing unit.

8. The system according to claim 7, wherein, when a displayed position of a property is changed on the content display screen by use of the input unit, the displayed content data creating unit acquires aggregated values of displayed position changed property from the content aggregating unit and creates displayed content data for displaying acquired content on a moved position of the displayed position changed property.

9. A method of displaying content comprising:
storing dictionary data into a dictionary-data storing unit defined according to a hierarchical data model in which an upper class inherits a property to a lower class;
storing content described based on the dictionary data into a content storing unit;
acquiring metadata of each property from the dictionary data present in the dictionary-data storing unit;
creating group information by grouping properties based on the metadata;
storing the group information into a group-information storing unit;
searching the dictionary data present in the dictionary-data storing unit and the content present in the content storing unit and creating displayed content data;
displaying on a display unit a content display screen based on the displayed content data;
selecting with an input unit a property displayed on the content display screen;
aggregating, when a property is selected with the input unit on the content display screen, values of selected property based on group information of the selected property present in the group-information storing unit.

10. The method according to claim 9, wherein, when a displayed position of a property is changed on the content display screen by use of the input unit, the searching includes acquiring values of displayed position changed property aggregated in the aggregating and create displayed content data for displaying acquired content on a moved position of the displayed position changed property.
